(19) United States
(12) Patent Application Publication
(10) Pub. No.: US 2014/0326367 A1
(43) Pub. Date: Nov. 6, 2014

(54) Metal Coating Method

(71) Applicant: THE LUND INDUSTRIAL GROUP, Holly Springs, MS (US)

(72) Inventor: Earl E. Hill, Rossville, TN (US)

(73) Assignee: THE LUND INDUSTRIAL GROUP, Holly Springs, MS (US)

(21) Appl. No.: 14/173,059

(22) Filed: Feb. 5, 2014

Related U.S. Application Data
(60) Provisional application No. 61/818,436, filed on May 1, 2013.

(51) Int. Cl. B05D 3/02; C21D 1/18; B05D 3/00

(52) U.S. Cl. CPC B05D 3/0254; B05D 3/007; C21D 1/18
USPC 148/537; 148/28

(57) ABSTRACT

This invention discloses a metal coating method whereby an abrasion resistant and wear resistant coating is first applied to the metal object, the coated metal object is then fused onto the metal object and the resulting coated metal object is more abrasion resistant and wear resistant while retaining the metal object's original shape.

### CROSS-REFERENCE TO RELATED APPLICATIONS

| | | |
|---|---|---|
| 7,631,702 | December, 2009 | Hansen |
| 6,264,886 | July 2001 | Mizuta |
| TBD | November, 2013 | Hill |
| 61/818,436 | May, 2013 | Hill |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

1. Field of the Invention

This invention discloses a metal coating method whereby an abrasion resistant and wear resistant coating is first applied to the metal object, the coating is then fused onto the metal object such that the resulting coated metal object is more abrasion resistant and wear resistant while retaining the metal object's original shape.

2. Background of the Invention

Metal objects such as disks and blades are used in the agricultural and construction industries to breakup soil and other materials. During the use of these metal objects, they are exposed to abrasive conditions that cause the objects to wear out. Several attempts have been made to extend the life of the objects by affixing abrasive resistant and wear resistant coatings onto the metal objects, which would then decrease maintenance time and replacement costs. Pasted on abrasive resistant and wear resistant coatings scrape off during use of the metal object. Well known fusing techniques deform the metal object and change the hardness properties of the metal due to heating involved in the application techniques. This metal coating method discloses a fusing technique that allows an abrasive resistant and wear resistant coating to be fused to a metal object while insuring that the metal object retains its initial shape and hardness.

In U.S. Pat. No. 7,631,702 Hansen claims a fused hard-faced double coated rotary tempered metal harrow disk blade, which, because it is concave, by its nature retains its shape upon cooling. The metal coating method described herein is for applying a durable coating to a tempered metal object that is not concave. The coating may be applied to one side or both sides of the metal object to result in a metal object that is abrasion and wear resistant. And when cooled after the fusing technique, the original shape of the metal object is preserved.

In U.S. Pat. No. 6,264,886 Mizuta teaches a method of fusing metallic powder into a solid with a predetermined shape by pouring the metallic powder into a mold and then heating until the powder is fused into a solid, whereas the present disclosure reveals a method of fusing a metallic coating onto a metal object while retaining the shape and hardness of said metal object.

In U.S. Patent Application TBD Hill, filed concurrently with this application, teaches of a press-quench machine for the purpose of cooling heated metal objects while holding the metal object under pressure to ensure that the shape of the metal object before heating is retained.

In U.S. Patent Application 61/818,436 Hill teaches of a wear coating and method of application to a flat agricultural disk.

### SUMMARY OF THE INVENTION

A method of applying an abrasive resistant and wear resistant coating to metal objects where the metal object is first cleaned to remove rust, dirt and other foreign material from the surface of the metal object, followed by coating all or a portion of the metal object with an abrasive resistant and wear resistant coating, the coated metal object then being thermally treated in an atmosphere controlled furnace to fuse the abrasive resistant and wear resistant coating to the metal object producing a coated metal object. The coated metal object is then removed from the atmosphere controlled furnace and inserted into a press-quench machine that applies pressure to the coated metal object to ensure that the original shape of the metal object is maintained while the coated metal object is submersed into a quenchant bath and cooled below the curing point of the metal object. After cooling, the coated metal object can be tempered to ensure proper hardness.

### BRIEF DESCRIPTION OF THE SEVERAL VIEWS OF THE DRAWING

FIG. 1 is a one-line drawing of the method of coating a metal object.

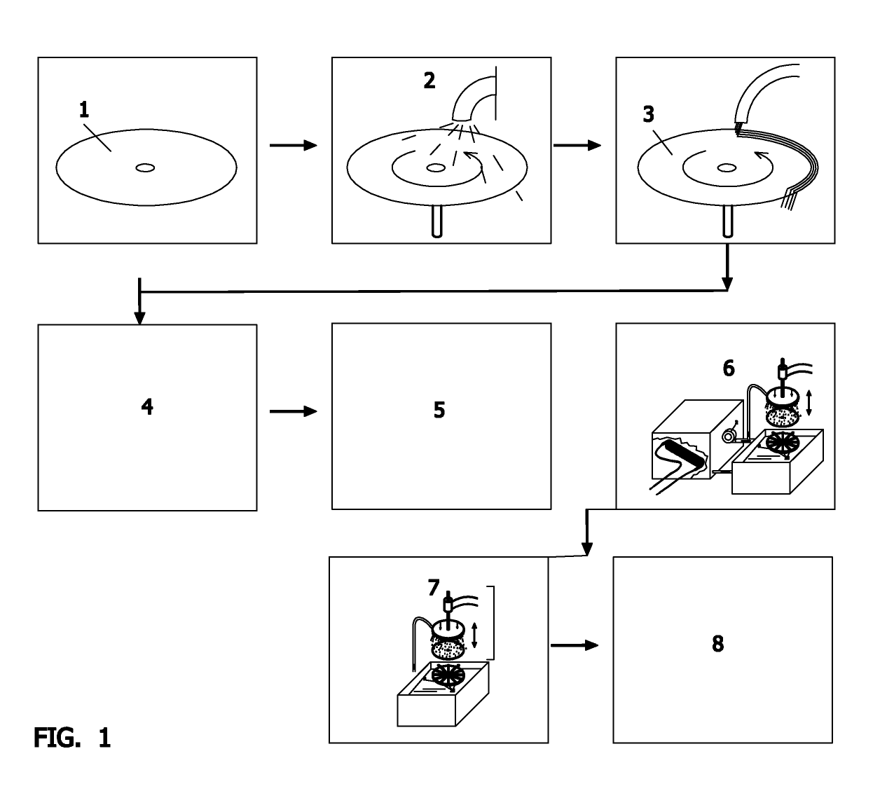

### DETAILED DESCRIPTION OF THE INVENTION

A method of coating a metal object 1 that makes the resulting coated metal object more resistant to abrasion and wear while retaining the metal object's original shape and hardness comprising first a means of cleaning 2 the metal object, then a means of coating 3 the metal object with the abrasive resistant and wear resistant coating. The abrasive resistant and wear resistant coating being applied by any one or a combination of the methods including but not limited to pouring, brushing, spraying, or dipping. Once the abrasive resistant and wear resistant coating is applied, the coated metal object is dried 4 and then inserted into an atmosphere controlled furnace 5 to fuse the coating to the metal object. The coated metal object is then removed from the atmosphere controlled furnace 5, inserted into a press-quench machine 6 which holds the coated metal object under pressure in order to retain the original shape of the metal object, submerged into the quenchant bath 7 of the press-quench machine 6, and the coated metal object remains submerged until the coated metal object is cooled below the curing point of the metal object. After cooling, the coated metal object can be tempered 8 to ensure proper hardness.

One preferred embodiment involves affixing the wear resistant and abrasion resistant coating along the outside perimeter of a flat circular blade surface, fusing said coating to the flat circular blade in an atmosphere controlled furnace, removing said coated flat circular blade from the furnace at the appropriate temperature, and inserting said coated flat circular blade into a press-quench machine to cool while ensuring that the coated flat circular blade retains its original shape, and then tempering the coated flat circular blade 6 back to the appropriate hardness.

A second preferred embodiment involves affixing the wear resistant and abrasion resistant coating along the outside perimeter of an undulating circular blade, fusing said coating to the undulating circular blade in an atmosphere controlled furnace, removing the coated undulating circular blade from the furnace at the appropriate temperature, and inserting said coated undulating circular blade into a press-quench machine to cool while ensuring that the coated undulating circular blade retains its original shape, and then tempering the coated undulating circular blade back to the appropriate hardness.

What is claimed:

1. A method of increasing the durability of metal objects by applying a coating onto the metal object's surface, said method comprising:
cleaning the metal object with the use of abrasives to remove dirt, rust and other foreign material;
coating the metal object by pouring, spraying, dipping, or brushing said abrasion resistant and wear resistant coating onto the surface of the metal object in the area to be coated;
fusing the coated metal object in an atmosphere controlled furnace;
removing the coated metal object from the atmosphere controlled furnace before the coated metal object is allowed to cool below the curing point;
inserting the coated metal object into a press-quench machine, activating the press-quench machine so that the press-quench machine applies pressure to the coated metal object in a method so as to ensure that the original shape of the metal object, followed by submerging the coated metal object in the quenchant bath of the press-quench machine until the coated metal object is cooled below the curing point of the metal object; and
tempering the coated metal object to ensure proper hardness.

2. The quenchant bath of claim 1 wherein the quenchant bath is comprised of oil quenchant or synthetic quenchant.
